(19) United States
(12) Patent Application Publication
(10) Pub. No.: US 2007/0098170 A1
(43) Pub. Date: May 3, 2007

(54) Digital broadcasting conditional access system and method using authorization revocation list

(75) Inventors: Han-Seung Koo, Daejeon (KR); O-Hyung Kwon, Daejeon (KR); Soo-In Lee, Daejeon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/492,092

(22) Filed: Jul. 25, 2006

(30) Foreign Application Priority Data
Nov. 3, 2005 (KR) 10-2005-0104877

(51) Int. Cl. H04N 7/167

(52) U.S. Cl. 380/239

(57) ABSTRACT

Provided is a digital broadcasting conditional access system and method using an Authorization Revocation List (ARL) for preventing an illegal pay broadcasting viewing after a secession time by promptly revoking an entitlement of pay service seceders through a periodical transmission of ARL that is daily or monthly prepared and updated to subscribers. The invention system comprises an ARL providing unit for creating daily and monthly ARLs separately and updating the ARLs based on service secession information of subscribers, a Subscriber Management System (SMS) for receiving service secession requests from subscribers and delivering the requests to the ARL providing unit, a Subscriber Authorization System (SAS) for producing an Entitlement Control Message (ECM) and an Entitlement Management Message (EMM) for subscriber authorization at a receiving end by using the daily and the monthly ARLs managed by the ARL providing unit, and a transmitting unit for periodically transmitting the ECM to subscribers via an in-band channel and the EMM via an out-of-band channel.

### FIELD OF THE INVENTION

The present invention relates to a digital broadcasting conditional access system and method using an Authorization Revocation List (ARL); and more particularly, to a digital broadcasting conditional access system and method using an ARL for preventing an illegal pay broadcasting viewing after a secession time by promptly revoking an entitlement of pay service seceders through a periodical transmission of ARL that is daily or monthly prepared and updated to subscribers.

### DESCRIPTION OF RELATED ART

In digital broadcasting conditional access system, subscribers may freely join in and secede from or leave pay broadcasting services. This digital broadcasting conditional access system transmits an entitlement key to a subscriber upon joining or cancels the key upon secession whenever there is a joining for pay services or secession therefrom. The entitlement key refers to an Authorization Key (AK) in case of a 3-layer key model shown in FIG. 1 and a Receiving Group Key (RGK) in case of a 4-layer key model in FIG. 2.

A common pay service joining procedure for subscribers is relatively simpler than a seceding procedure as follows.

First, a subscriber who wants to join in a service gives an application for a desired service to a head-end conditional access system on-line or off-line. Then, the head-end conditional access system authenticates a validation of the subscriber.

If the authentication result shows that the application is from the valid subscriber, the head-end conditional access system updates the applied contents of pay service and then sends an entitlement key required for viewing to the subscriber. As mentioned above, the entitlement key may be an AK in case of 3-layer key transmission model shown in FIG. 1 and an RGK in case of 4-layer key transmission model in FIG. 2. Meanwhile, if the subscriber who applied for the pay service doesn't have the required entitlement key, the head-end conditional access system creates a new key and then sends it to the subscriber. Then, the subscriber receives the new key sent from the head-end conditional access system and again makes an application for the pay service.

On the other hand, the pay service seceding procedure is carried out as below.

First of all, a subscriber gives an application for secession of a specific pay service to the head-end conditional access system on-line or off-line. Then, the head-end conditional access system authenticates a validation for the secession application of the subscriber. If the authentication result shows that there is no problem with the secession application of the subscriber, the head-end conditional access system transmits entitlement keys to only subscribers excluding the subscriber who made the secession application upon a next entitlement key updating.

In this conventional seceding method, however, the subscriber who has already made the secession application can continue to view the pay broadcasting from the secession time to the update time of the entitlement key. Moreover, there is no idea or method to prevent such an illegal viewing.

For example, if a subscriber makes an application for secession at 00:01 and an entitlement key is updated at 24:00, the subscriber is illegally allowed to view pay broadcasting for 23 hours and 59 minutes for which he/she has no entitlement to view such pay broadcasting. That is, if the update period is 24 hours, it is possible to do the illegal viewing for a maximum 24 hours.

### SUMMARY OF THE INVENTION

It is, therefore, a primary object of the present invention to provide a digital broadcasting conditional access system and method using an ARL for preventing an illegal pay broadcasting viewing after a secession time by promptly revoking an entitlement of pay service seceders through a periodical transmission of ARL that is daily or monthly prepared and updated to subscribers.

In accordance with one aspect of the present invention, there is provided a digital broadcasting conditional access system using Authorization Revocation List (ARL) for transmitting service secession information to a receiving end or host for conditional access of broadcasting services, comprising: an ARL providing means for creating daily and monthly ARLs separately and updating the ARLs based on the service secession information of subscribers; a Subscriber Management System (SMS) means for receiving service secession requests from subscribers and delivering the requests to the ARL providing means; a Subscriber Authorization System (SAS) means for producing an Entitlement Control Message (ECM) and an Entitlement Management Message (EMM) for subscriber authorization at the receiving end by using the daily and the monthly ARLs managed by the ARL providing means; and a transmitting means for periodically transmitting the ECM to subscribers via an in-band channel and the EMM via an out-of-band channel.

In accordance with another aspect of the present invention, there is provided a service conditional access method using an ARL in a head-end or sending unit of a digital broadcasting conditional access system, comprising the steps of: (a) creating and disusing a daily ARL, and updating the ARL_{today} whenever there is a request for subscriber secession; (b) generating and disusing a monthly ARL, and updating the monthly ARLₗₐₛₜ by day unit when there is a request for subscriber secession; (c) periodically inserting the daily ARL_{today} into an ECM and transmitting the inserted message to subscribers; and (d) periodically inserting the monthly ARLₗₐₛₜ into an ECM and transmitting the inserted message to subscribers.

In accordance with still another aspect of the present invention, there is provided a service conditional access method using an ARL in a host or subscriber receiving unit of a digital broadcasting conditional access system, comprising the steps of: (a) receiving an ECM or EMM periodically transmitted form a head-end; (b) extracting an ARL from the received ECM or EMM; (c) interpreting the extracted ARL to confirm whether or not service secession information has corresponding subscriber information of the host; (d) if the confirmation result at said step (c) shows that there is the corresponding subscriber information of the host, deleting an entitlement key of the corresponding subscriber; and (e) if the confirmation result at said step (c) shows that there is no corresponding subscriber information of the host, allowing the reception of broadcasting.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram showing a configuration of a 3-layer key transmission model of a common digital broadcasting conditional access system;

FIG. 2 is a block diagram showing a configuration of a 4-layer key transmission model of a common digital broadcasting conditional access system;

FIG. 3 is a block diagram showing a configuration of a head-end of a digital broadcasting conditional access system using an ARL in accordance with an embodiment of the invention;

FIGS. 4a and 4b are diagrams showing structures of an ECM_{ARL} and an EMM_{ARL} in accordance with an embodiment of the invention, respectively;

FIG. 5 is a diagram for describing a method of inserting an ARL_{today} into the ECM_{ARL} in accordance with an embodiment of the invention; and

FIG. 6 is a flowchart illustrating a service conditional access method using the ARL in a subscriber reception unit or host in accordance with an embodiment of the invention.

### DETAILED DESCRIPTION OF THE INVENTION

The above-mentioned objectives, features, and advantages will be more apparent by the following detailed description associated with the accompanying drawings; and based on this, the invention will be readily conceived by those skilled in the art to which the invention pertains. Further, in the following description, well-known arts will not be described in detail if it seems that they could obscure the invention in unnecessary detail. Hereinafter, a preferred embodiment of the present invention will be set forth in detail with reference to the accompanying drawings.

The present invention makes use of an “ARL” with available period of one month as a basic charge term. The ARL contains secession information of subscribers who made applications for secession for specific pay broadcasting services, and is updated whenever subscribers give applications for secession to a head-end or sending system. This ARL is delivered to subscribers through an Entitlement Control Message (ECM) and an Entitlement Management Message (EMM).

The ARL_{today} delivered through the ECM contains information of subscribers who made applications for secession with respect to pay broadcasting services from 00:00 to 24:00. And, the ARLₗₐₛₜ delivered through the EMM includes information of subscribers who made applications for secession with respect to pay broadcasting services from the first day of a specific month to a day just before a day of delivering the ARL_{today} through the ECM. For example, if today is August 17, the ARL_{today} is sent to subscribers through the ECM having secession information occurred from 00:00 August 17 to a transmission time thereof while ARLₗₐₛₜ is transmitted to subscribers through the EMM having secession information taken place from 00:00 August 1 to 24:00 August 16.

In general, the ECM is repeatedly sent from the head-end to subscribers with very short period, e.g., 0.1 sec. Since the subscribers cannot view pay broadcasting without receipt of such ECM, they must receive such ECM. That is, if the head-end transmits the ARL_{today} through the ECM, the subscribers can receive the ARL_{today} with high reliability through the ECM that is very frequently transmitted.

However, if a size of the ARL is large, there is a possibility that its transmission through the ECM consumes a large channel bandwidth. Therefore, the present invention transmits only the ARL_{today} that is created during late one day on the basis of the current time, i.e., a transmission time of ARL. In addition, the ARLₗₐₛₜ that is created from the first day of that month to just the day before on the basis of the current time is sent through the EMM. The reason the previous ARL is continuously maintained during one month as above is for subscribers to ready for an instance where there is a failure to receive the ECM. Namely, although subscribers who made secession applications didn't receive the ECM for one day after the secession application, those subscribers are divested of entitlement of pay broadcast viewing if they receive the EMM until the end of that month. At this time, the transmission period of the EMM may be properly varied by the system operator based on the channel bandwidth.

A Conditional Access Module (CAM) of subscriber who received the ARL confirms whether or not its own subscriber information is involved in the secession information contained therein and deletes an entitlement key of the subscriber if any.

For example, if a subscriber makes an application for secession for pay broadcasting service, he/she immediately receives the ARL including his/her own secession information through the ECM. Then, a conditional access application in the CAM of the subscriber interprets the ARL and confirms the fact that his/her secession information is involved therein. Lastly, the conditional access application deletes an entitlement key corresponding to the secession information of the subscriber in the ARL from a memory within the CAM.

Although the subscriber who applied for the secession rejects the receipt of the ECM in any manner, he/she cannot view pay broadcasting without receipt of such ECM and thus cannot do illegal broadcasting viewing. Further, although the subscriber tries to view pay broadcasting on the next day after avoiding viewing for the day of making the secession application, he/she would receive the ARL that is periodically updated through the EMM, thereby allowing no illegal pay broadcasting viewing.

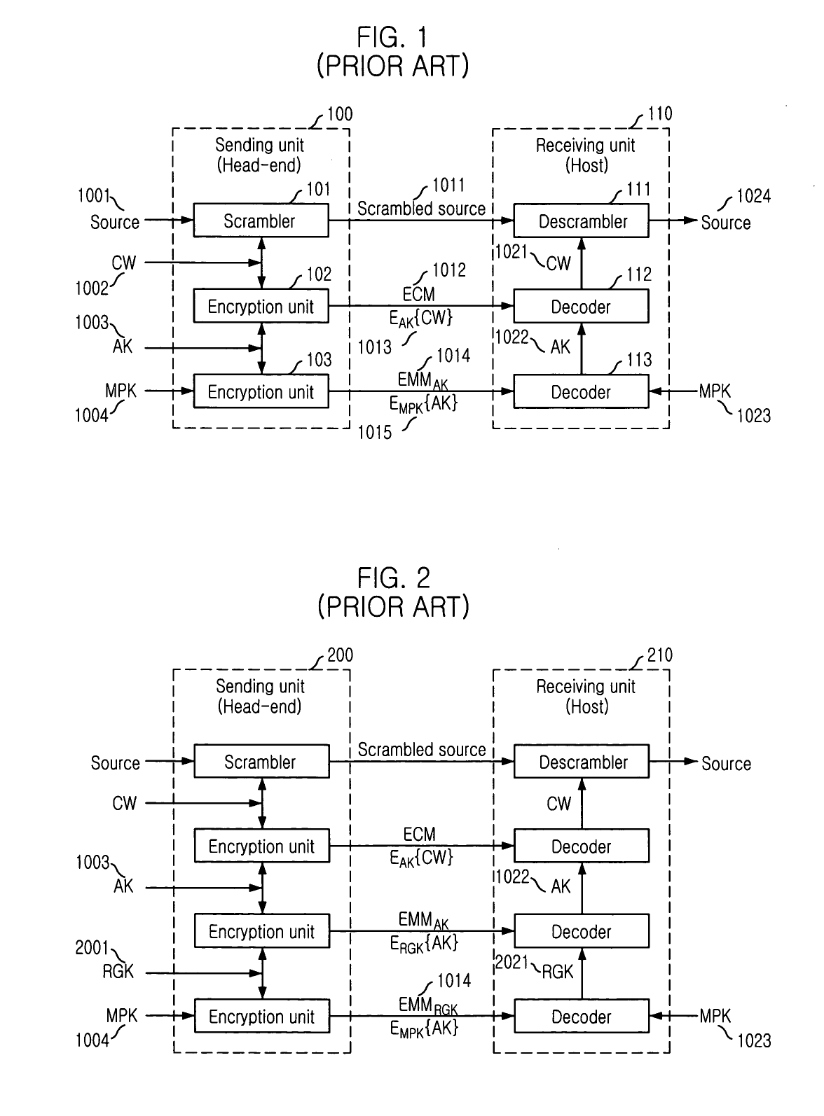

FIG. 1 is a block diagram showing a configuration of a 3-layer key transmission model of a common digital broadcasting conditional access system and FIG. 2 is a block diagram showing a configuration of a 4-layer key transmission model of a common digital broadcasting conditional access system.

First of all, there will be described a 3-layer key transmission model referring to FIG. 1.

In the 3-layer key transmission model, a head-end 100 as a sending unit includes a scrambler 101 and two encryptors 102 and 103; and a host 110 as a subscriber reception unit includes a descrambler 111 and two decryptors 112 and 113.

An Audio/Video (AV) source 1001 is encrypted by the scrambler 101 of the head-end 100. At this time, a Control Word (CW) is used as an encryption key.

The source 1011 so encrypted and sent is decrypted by the descrambler 111 of the host 110 to provide an original source 1024. Also, a CW is used as an encryption key for the decryption.

The head-end 100 must encrypt a CW 1002 and then send it to the host 110 so that the descrambler 111 can decrypt the scrambled source 1011 using a CW 1021. At this time, a message used in sending an encrypted CW 1013 is an ECM 1012.

The decryptor 112 of the host 110 decrypts the ECM 1012 by using an Authorization Key (AK) 1022 indicating a decryption key to obtain the CW 1021.

Since the CW 1002 in the head-end 100 is encrypted by an AK 1003, the head-end 100 must encrypt the AK 1003 and then send it to the host 110. Specifically, the head-end 100 encrypts the AK 1003 with a Multiple Public Key (MPK) 1004; and the encrypted AK 1015 is fed to the host 110 through an EMM message 1014.

In the host 110, the AK 1022 is derived by decrypting the received EMM message 1014 with the MPK 1023. As described above, the AK 1022 is used in decrypting the encrypted CW 1013. In this 3-layer key transmission model, the keys serving as an “entitlement key” are the AKs 1003 and 1022.

Meanwhile, in the 4-layer key transmission model shown in FIG. 2, one encryptor and one decryptor are further provided in a head-end 200 and a host 210, respectively, compared to the 3-layer key transmission model of FIG. 1.

In the 4-layer key transmission model, only following process is different from the process of the 3-layer key transmission model. That is, the head-end 200 encrypts an AK 1003 by using an RGK 2001 and then the RGK 2001 with an MPK 1004. And the host 210 decrypts an RGK 2021 by using an MPK 1023 and then an AK 1022 with the decrypted RGK 2021.

In this 4-layer key transmission model, the keys serving as an “entitlement key” are the RGKs 2001 and 2021.

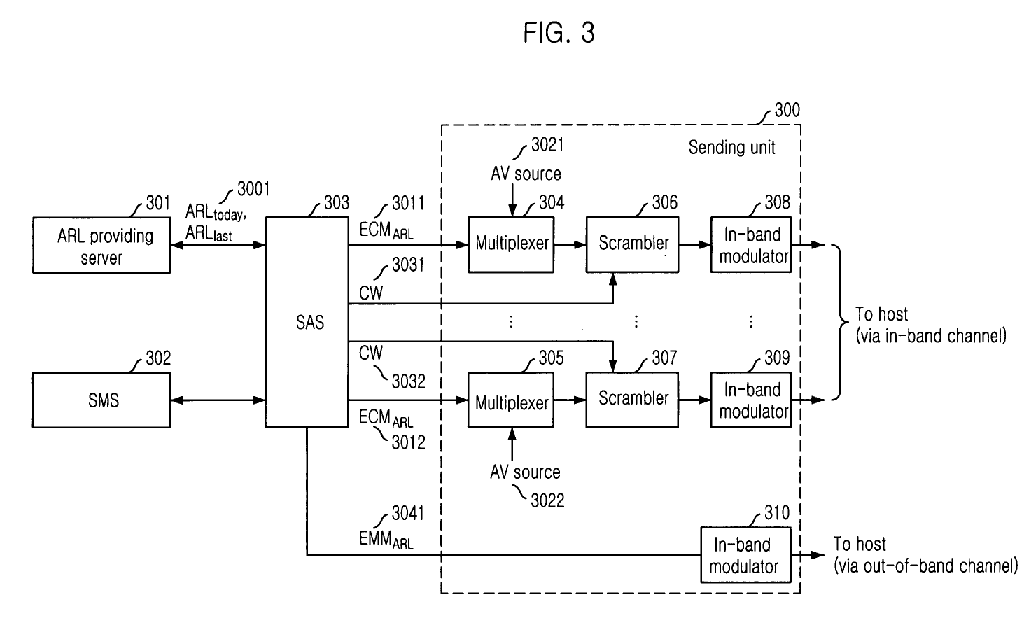

FIG. 3 is a block diagram showing a configuration of a head-end of a digital broadcasting conditional access system using an ARL in accordance with an embodiment of the invention.

As shown therein, a head-end conditional access system, that is, the head-end of the digital broadcasting conditional access system comprises an ARL providing server 301, a Subscriber Management System (SMS) 302, a Subscriber Authorization System (SAS), and a transmitting unit 300. And, the transmitting unit 300 includes multiplexers 304 and 305, scramblers 306 and 307, in-band modulators 308 and 309, and an Out-Of-Band (OOB) modem 310.

First, each of the components in the head-end will be explained in detail hereinafter. The ARL providing server 301 separately creates daily and monthly ARLs and updates them based on service secession information. More specifically, the ARL providing server 301 performs the following two functions. Firstly, it creates and disuses a daily ARL, and updates the daily ARL_{today} whenever there is secession request of subscribers. Secondly, it generates and disuses a monthly ARL, and updates the monthly ARLₗₐₛₜ by day unit upon a secession request of subscribers.

In the meantime, the SMS 302 receives a secession request for services from subscribers and sends it to the ARL providing server 301. And the SAS 303 produces an ECM and an EMM for subscriber authorization at a receiving end based on the daily ARL and the monthly ARL managed by the ARL providing server 301.

Then, the transmitting unit 300 transmits the ECM to subscribers over an in-band channel at a preset period of, e.g., 0.1 sec and the EMM to subscribers over an out-of-band channel at a preset period of, e.g., one day.

Hereinafter, a service conditional access method carried out in the head-end device using ARLs will be described, together with the head-end device.

The ARL providing server 301 serves to create or disuse an ARL. The ARL is newly created by the ARL providing server 301 in the first day of a month and reused in the end day of that month.

When a subscriber requests the SMS 302 of the head-end to secede pay services on-line or off-line, it causes the ARL providing server 301 to know the fact and then adds information of the subscriber who made the secession request to the ARL.

Next, the ARL providing server 301 delivers the newly updated ARL to the SAS 303. At this time, the ARL delivered is classified into a daily ARL_{today} 3001 and a monthly ARLₗₐₛₜ 3001 depending on the generation time of the ARL. The daily ARL_{today} 3001 contains an ARL created after 00:00 this day on the basis of the current time; and the monthly ARLₗₐₛₜ 3001 contains ARL created from the first day of this month to midnight yesterday on the basis of the current time.

Thereafter, the SAS 303 produces an ECM_{ARL} 3011 with the ARL_{today} 3001 and an EMM_{ARL} with the ARLₗₐₛₜ 3001, out of the ARL 3001. At this time, the ECMs_{ARL} 3011 are produced by the number of physical channels supported by the head-end. For example, if the head-end supports 100 physical channels, the SAS 303 should produce 100 number of ECMs_{ARL} 3011, each of which has an ARL of each channel.

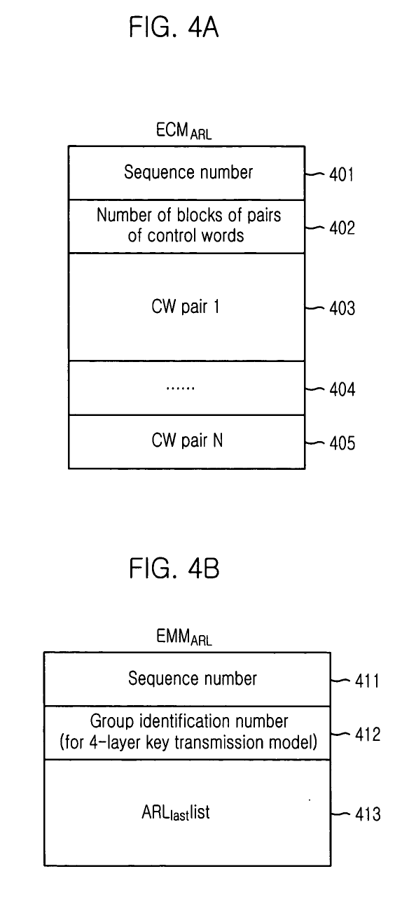

An example of producing a different ARL every physical channel is as follows. First, it is assumed that physical channels a subscriber #1 joined are CH1, CH3 and CH5, and physical channels a subscriber #2 joined are CH2, CH3 and CH6. And it is assumed that the two subscribers have all seceded from all the joined channels. In this case, the subscriber #1 is involved in the ARL of ECM_{ARL} corresponding to the physical channel CH1. And the subscribers #1 and #2 are involved in the ARL of ECM_{ARL} corresponding to the physical channel CH3. Lastly, the subscribers #1 and #2 are included in the ARL of ECM_{ARL} corresponding to the physical channels CH5 and CH6. If there are more than 2 virtual channels with respect to one physical channel, the SAS 303 sorts out and then sends secession subscribers for each virtual channel through the ECM_{ARL}, as shown in FIG. 4a.

The ECMs_{ARL} produced by the number of physical channels are sequentially passed through multiplexers (MUXS) 304, scramblers 306 and 307, and in-band modulators 308 and 309 that are prepared for each channel, and then lastly sent to the host via in-band channels. At this time, the ECMs_{ARL} 3011 and 3012 contain the ARL_{today} encrypted with the AK 1003 shown in FIG. 1.

The NUXs 304 and 305 multiplex the ECMs_{ARL} 3011 and 3012 from the SAS 303 and audio/video sources 3021 and 3022; and the scramblers 306 and 307 encrypt the multiplexed ECM_{ARL} with the CWs 3031 and 3032 and the audio/video source. The in-band modulators 308 and 309 modulate the encrypted ECM_{ARL} and the audio/video source.

The SAS 303 sends to subscribers the ARL created from the first day of this month to yesterday on the basis of the current time through the EMM_{ARL} 3041, excluding the ARL created this day provided through the ECMs_{ARL} 3011 and 3012. At this time, the EMM_{ARL} 3041 is sent to the host via the OOB modem 310.

The ARLₗₐₛₜ of EMM_{ARL} in the SAS 303 is encrypted with different keys depending on the 3-layer key transmission structure or model or the 4-layer key transmission structure or model. In the 3-layer key transmission structure, the ARLₗₐₛₜ in EMM_{ARL} is encrypted through the MPK 1004 as shown in FIG. 1, indicating a unique encryption key every subscriber. Therefore, the SAS 303 must create and send the EMMs_{ARL} by the number of subscribers in case of using the 3-layer key transmission structure.

On the other hand, in the 4-layer transmission structure, the ARLₗₐₛₜ in EMM_{ARL} is encrypted with an RGK 2001 indicating a group key of a service group each subscriber joined. Therefore, the SAS 303 must create and send the EMMs_{ARL} by the number of groups in case of using the 4-layer transmission structure.

FIGS. 4a and 4b are diagrams showing structures of the ECM_{ARL} and the EMM_{ARL} in accordance with an embodiment of the invention, respectively.

First, an explanation of each field constituting the ECM_{ARL} as shown in FIG. 4a will be given as below.

The ECM_{ARL} massage is composed of a sequence number field 401, a number of Control Words (CW) pair blocks field 402, and N CW pair fields 403 to 405.

Specifically, the sequence number field 401 is configured to confirm the sequence of messages inputted to the CAM used in the host 110 or 210 of FIG. 1 or 2. If the ECM_{ARL} with same sequence number or previous sequence number is inputted, the CAM doesn't take this.

The number of CW pair blocks field 402 denotes the number of the CW pair blocks 403, 404 and 405 corresponding to the number of virtual channels that can be processed by one ECM_{ARL}. If the number of virtual channels that can be processed by one ECM_{ARL} is 4, the number of CW pair blocks 402 becomes 4 and thus has 4 control words pair blocks 403, 404, 405.

The CW pair blocks fields 403, 404 and 405 include ARL_{today} 3001 encrypted with the AK, in addition to a channel ID, an odd/even selection flag, and an odd/even CW basically contained in the ECM. To organize the ECM_{ARL} so, the SAS 303 sorts out the ARL_{today} provided from the ARL providing server 301 by each channel ID of virtual channel and then inserts them into corresponding CW pair blocks 403, 404 and 405. Namely, each of the CW pair blocks 403, 404 and 405 contains secession subscriber information sorted out by each virtual channel.

Next, an explanation of each field constituting the EMM_{ARL} message shown in FIG. 4b will be provided as follows.

The EMM_{ARL} message is composed of a sequence number field 411, a group ID field 412, and an ARLₗₐₛₜ list field 413.

Specifically, the sequence field 411 is the same as the field 401 of FIG. 4a. And the group ID field 412 is valid only when the head-end conditional access system makes use of the 4-layer key transmission structure and represents an ID value for subscriber group corresponding to the ARLₗₐₛₜ contained in the EMM_{ARL}.

The ARLₗₐₛₜ list field 413 includes the entire list of the ARLₗₐₛₜ in case of the 3-lay key transmission structure; and is encrypted with the MPK 1004 and sent to each subscriber. Meanwhile, the ARLₗₐₛₜ list field 413 includes only ARL corresponding to a group that the group ID indicates out of the entire list of the ARLₗₐₛₜ in case of the 4-lay key transmission structure. This field is encrypted with the RGK 2001 and then sent to each subscriber group.

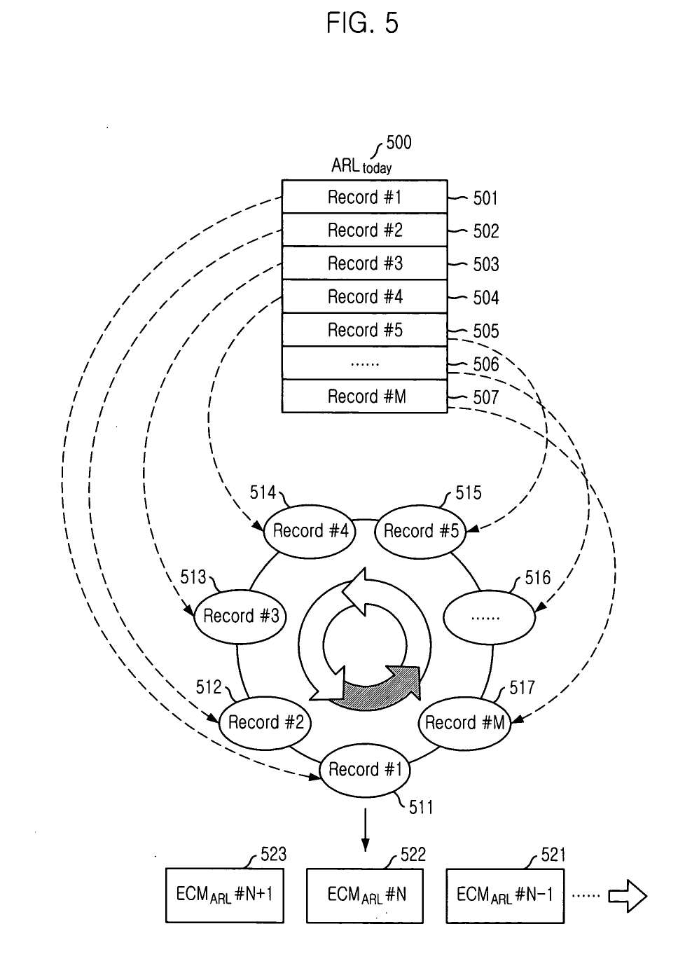

FIG. 5 is a diagram for describing a method of inserting the ARL_{today} into the ECM_{ARL} in accordance with an embodiment of the invention.

The invention inserts each record of the ARL_{today} into the ECM_{ARL} by using a carousel scheme, as shown in FIG. 5. Using this scheme, the ARL_{today} can be effectively inserted into the ECM_{ARL} although the size of ARL_{today} is larger or less than the ECM_{ARL} with fixed size.

First, if the number of records of the daily ARL_{today} is less than the number of records that can be processed by one ECM, all record information of the daily ARL_{today} is inserted into one ECM for transmission. For example, it is assumed that a record #M 507 value of an ARL_{today} 500 is “6” and one ECM_{ARL} 521, 522 or 523 can process by 6 records at a time. In this case, each of the ECM_{ARL} 521, 522 and 523 sent to the host includes all the records, i.e., 6 records of the ARL_{today} 501.

On the other hand, if the number of records of the daily ARL_{today} exceeds the number of records that can be processed by one ECM, each of all record information of the daily ARL_{today} is sequentially inserted into plural ECMs transmitted in order until all the record information of the daily ARL_{today} is inserted.

For instance, it is assumed that the record #M 507 value is “12” and one ECM_{ARL} 521, 522 or 523 can process by 6 records at a time. In such a case, the first ECM_{ARL} 521 sent to the host includes first to sixth records of the ARL_{today} 500 and the second ECM_{ARL} 522 includes seventh to twelfth records of ARL_{today} 500. Thereafter, if there is no additional record in the ARL_{today} 500, the third ECM_{ARL} 523 again includes first to sixth records of the ARL_{today} 500. If the second ECM_{ARL} 522 is sent with the seventh to twelfth records of the ARL_{today} 500 and then the thirteenth record is added to the ARL_{today} 500, the third ECM_{ARL} 523 is sent with 6 of the thirteenth to fifth records of the ARL_{today} 500. This process is recursively performed as shown in FIG. 5.

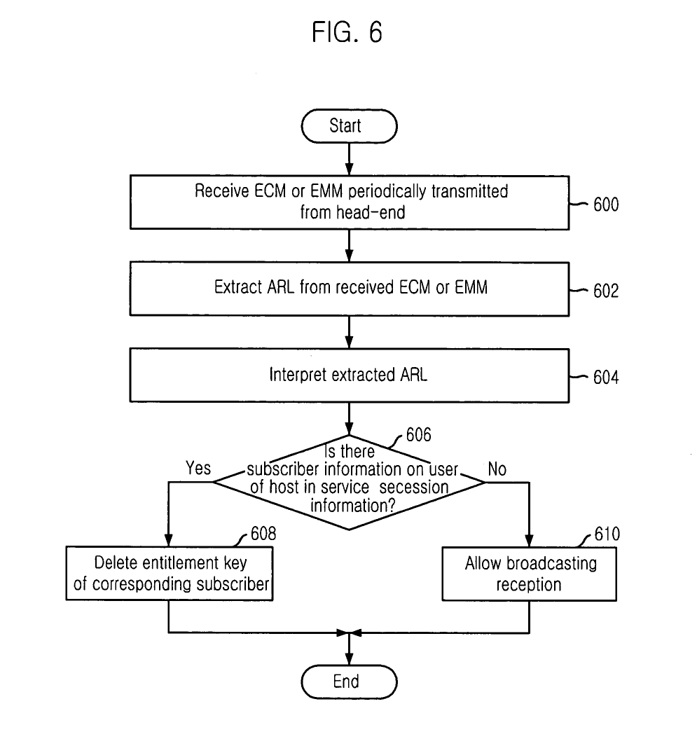

FIG. 6 is a flowchart illustrating a service conditional access method using the ARL in the subscriber reception unit or the host in accordance with an embodiment of the invention. This is already described above; and therefore, a schematic description thereof will be given below referring to FIG. 6.

At a first step S600, the host receives an ECM or EMM periodically transmitted from the head-end, as shown in FIG. 3. And then, it extracts an ARL from the received ECM or EMM at step S602. A daily ARL is extracted from the ECM, while a monthly ARL is extracted from the EMM, wherein each of them is the same as already explained early.

Next, the host interprets the extracted ARL at step 604, and confirms whether subscriber information on the user of the host is involved in service secession information acquired by the interpretation at step S606.

If the confirmation result shows that there is the subscriber information, the host deletes an entitlement key of the subscriber at step S608; and if the confirmation result shows that there is no subscriber information, the host is allowed to receive broadcasting at step S610. At this time, if the subscriber doesn't receive the entitlement key validly updated, of course, the host is not allowed to receive the broadcasting. The above entitlement key deleting process is made by deleting the entitlement key of the subscriber stored in the CAM.

As described above, the present invention can effectively update an entitlement key when a subscriber makes an application for pay service secession in a digital broadcasting conditional access system. In other words, the invention can prevent an illegal pay broadcasting viewing by promptly revoking an entitlement of a subscriber who made an application for pay service secession by using an ARL.

In general, since an ECM not only has a very short transmission period of, e.g., 01 sec but also subscribers are not fundamentally allowed to receive pay broadcasting services without receipt of an ECM, the transmission of an ARL using such ECM is very effective. Accordingly, the invention transmits an ARL created during late one day on the basis of the current time through an ECM to subscribers out of ARLs, thereby allowing no broadcasting reception for seceders by promptly revoking an entitlement of pay service seceders.

Moreover, the invention transmits an ARL generated from the first day of this month to just the day before on the basis of the current time through an EMM, and therefore, can considerably reduce system load caused by increase of such ARL.

The method of the present invention as mentioned above may be implemented by a software program and stored in a computer-readable storage medium such as CD-ROM, RAM, ROM, floppy disk, hard disk, optical magnetic disk, etc. This process may be readily carried out by those skilled in the art; and therefore, details of thereof are omitted here.

The present application contains subject matter related to Korean patent application No. 2005-0104877, filed with the Korean Intellectual Property Office on Nov. 03, 2005, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A digital broadcasting conditional access system using Authorization Revocation List (ARL) for transmitting service secession information to a receiving end or host for conditional access of broadcasting services, comprising:
an ARL providing means for creating daily and monthly ARLs separately and updating the ARLs based on the service secession information of subscribers;
a Subscriber Management System (SMS) means for receiving service secession requests from subscribers and delivering the requests to the ARL providing means;
a Subscriber Authorization System (SAS) means for producing an Entitlement Control Message (ECM) and an Entitlement Management Message (EMM) for subscriber authorization at the receiving end by using the daily and the monthly ARLs managed by the ARL providing means; and
a transmitting means for periodically transmitting the ECM to subscribers via an in-band channel and the EMM via an out-of-band channel.

2. The digital broadcasting conditional access system as recited in claim 1, wherein the ARL providing means includes:
a daily ARL managing step of creating and disusing a daily ARL, and updating the ARL_{today} whenever there is a request for subscriber secession; and
a monthly ARL managing step of generating and disusing a monthly ARL, and updating the ARLₗₐₛₜ by day unit when there is a request for subscriber secession.

3. The digital broadcasting conditional access system as recited in claim 2, wherein the daily ARL managing step creates and manages a daily ARL_{today} separately every physical channel supported by a head-end or sending unit.

4. The digital broadcasting conditional access system as recited in claim 3, wherein the SAS means creates an ECM separately every physical channel supported by the head-end and inserts into each ECM the daily ARL_{today} for a corresponding channel.

5. The digital broadcasting conditional access system as recited in claim 4, wherein each ECM in the SAS means contains a sequence number field, a number of control words pair block field indicating the number of virtual channels that belong to one physical channel, a control words pair block field for each virtual channel, each control words pair block field having channel identification (ID) information, a pair of control words, secession subscriber information classified by each virtual channel.

6. The digital broadcasting conditional access system as recited in claim 5, wherein the daily ARL insertion is made by inserting each record value of the daily ARL_{today} into the control words pair block of the ECM using a carousel scheme.

7. The digital broadcasting conditional access system as recited in claim 6, wherein the carousel scheme inserts all record information of the daily ARL_{today} into one ECM if the number of records of the daily ARL_{today} is less than the number of records that can be processed by one ECM; and sequentially inserts each of all the record information of the daily ARL_{today} into a plurality of ECMs transmitted in sequence until all the record information of the daily ARL_{today} is inserted if the number of records of the daily ARL_{today} exceeds the number of records that can be processed by one ECM.

8. The digital broadcasting conditional access system as recited in claim 2, wherein the monthly ARLₗₐₛₜ in the monthly ARL managing step contains all secession information occurred from the first day of a specific month to a day before a day of transmitting the monthly ARLₗₐₛₜ to subscribers.

9. The digital broadcasting conditional access system as recited in claim 8, wherein the monthly ARL managing step creates EMMs by the number of subscribers if the system is a 3-layer key transmission model, and
the EMM in the SAS means is created by inserting the monthly ARLₗₐₛₜ encrypted with unique Multiple Public Key (MPK) every subscriber into each of the created EMMs.

10. The digital broadcasting conditional access system as recited in claim 8, wherein the monthly ARL managing step creates EMMs by the number of subscribers if the system is a 4-layer key transmission model, and
the EMM in the SAS means is created by encrypting the monthly ARLₗₐₛₜ with unique Receiving Group Key (RGK) every group and inserting the encrypted monthly ARLₗₐₛₜ and a corresponding group ID into each of the created EMMs.

11. A service conditional access method using an ARL in a head-end or sending unit of a digital broadcasting conditional access system, comprising the steps of:
(a) creating and disusing a daily ARL, and updating the ARL_{today} whenever there is a request for subscriber secession;
(b) generating and disusing a monthly ARL, and updating the monthly ARLₗₐₛₜ by day unit when there is a request for subscriber secession;
(c) periodically inserting the daily ARL_{today} into an ECM and transmitting the inserted message to subscribers; and
(d) periodically inserting the monthly ARLₗₐₛₜ into an ECM and transmitting the inserted message to subscribers.

12. The service conditional access method as recited in claim 11, wherein the daily ARL_{today} in said step (a) is created and managed separately every physical channel supported by the head-end.

13. The service conditional access method as recited in claim 12, wherein said step (c) inserts the daily ARL_{today} for each channel into an ECM of said each channel and transmits the inserted message to subscribers.

14. The service conditional access method as recited in claim 11, wherein the monthly ARLₗₐₛₜ contains all secede information occurred from the first day of a specific month to prior to a day of transmitting the monthly ARLₗₐₛₜ to subscribers.

15. The service conditional access method as recited in claim 11, wherein the daily ARL insertion in said step (c) is made by inserting each record value of the daily ARL_{today} into the control words pair block of the ECM using a carousel scheme.

16. The service conditional access method as recited in claim 15, wherein said step (d) creates EMMs by the number of subscribers if the digital broadcasting conditional access system is a 3-layer key transmission model; and encrypts the monthly ARLₗₐₛₜ with unique MPK every subscriber and inserts the encrypted monthly ARLₗₐₛₜ into each of the created EMMs.

17. The service conditional access method as recited in claim 15, wherein said step (d) creates EMMs by the number of service groups if the digital broadcasting conditional access system is a 4-layer key transmission model; and encrypts the monthly ARLₗₐₛₜ with unique RGK every group and inserts into each of the created EMMs the encrypted monthly ARLₗₐₛₜ and a corresponding group ID.

18. A service conditional access method using an ARL in a host or subscriber receiving unit of a digital broadcasting conditional access system, comprising the steps of:
(a) receiving an ECM or EMM periodically transmitted form a head-end;
(b) extracting an ARL from the received ECM or EMM;
(c) interpreting the extracted ARL to confirm whether or not service secession information has corresponding subscriber information of the host;
(d) if the confirmation result at said step (c) shows that there is the corresponding subscriber information of the host, deleting an entitlement key of the corresponding subscriber; and
(e) if the confirmation result at said step (c) shows that there is no corresponding subscriber information of the host, allowing the reception of broadcasting.

19. The service conditional access method as recited in claim 18, wherein the ARL includes a daily ARL contained in the ECM and a monthly ARL contained in the EMM.

20. The service conditional access method as recited in claim 18, wherein said step (d) deletes the entitlement key of the corresponding subscriber stored in a Conditional Access Module (CAM) if there is the corresponding subscriber information of the host.
